(19) United States
(12) Patent Application Publication
(10) Pub. No.: US 2014/0159488 A1
(43) Pub. Date: Jun. 12, 2014

(54) Power Distribution System and Power Distribution Unit

(71) Applicant: Huawei Technologies Co., Ltd., Shenzhen (CN)

(72) Inventors: Zhuo Tang, Shenzhen (CN); Zhen Luo, Shenzhen (CN); Yang Zhu, Shenzhen (CN)

(73) Assignee: Huawei Technologies Co., Ltd., Shenzhen (CN)

(21) Appl. No.: 14/080,958

(22) Filed: Nov. 15, 2013

Related U.S. Application Data
(63) Continuation of application No. PCT/CN2013/080941, filed on Aug. 7, 2013.

(30) Foreign Application Priority Data
Dec. 11, 2012 (CN) 201210531926.4

(51) Int. Cl. H02J 1/00

(52) U.S. Cl. CPC H02J 1/00
USPC 307/39

(57) ABSTRACT

The present invention discloses a power distribution system and a power distribution unit. The power distribution system includes a cable module, an electrical device, and a power distribution unit, where the power distribution unit includes a first input end, a second input end, a first output end, a second output end, a fourth connector, a controlled switch, and a first sensing module configured to sense whether a second connector plugged into the fourth connector is unplugged; if yes, generate a second drive signal to a drive end of the controlled switch; and if no, generate a first drive signal to the drive end of the controlled switch.

### CROSS-REFERENCE TO RELATED APPLICATIONS

This application is a continuation of International Application No. PCT/CN2013/080941, filed on Aug. 7, 2013, which claims priority to Chinese Patent Application No. 201210531926.4, filed on Dec. 11, 2012, both of which are hereby incorporated by reference in their entireties.

### TECHNICAL FIELD

Embodiments of the present invention relate to the field of power supply technologies, and in particular, to a power distribution system and a power distribution unit.

### BACKGROUND

In an existing equipment room of a data center, it is becoming a trend in an overall context of energy conservation and emission reduction that conventional alternating current Uninterruptible Power Supply (UPS) and distribution architecture evolves toward 240 Volt (V) high-voltage direct current (HVDC) power supply architecture for the data center. At present, most first input connectors of numerous commercial information technology (IT) devices use a C13 or C19 connector according to an International Electrotechnical Commission (IEC) standard. When the 240 V HVDC power supply is promoted to numerous old equipment rooms or in power supply and distribution reconstruction, an input connector C13 or C19 of an electrical device will not be changed. Considering that an electrical device such as a server is universal in a wide range, a device supplier is unwilling to replace a standard interface and an interior first structure of a new product for the communications field. However, when the C13 or C19 connector according to the IEC standard is used for a 240 V HVDC high-voltage direct current voltage, high-voltage direct current electric arc blast may be caused in a plugging and unplugging process, which may injure an operator.

As shown in FIG. 1, in a process of transforming an equipment room of an existing data center using an alternating current UPS power supply into one using a 240 V HVDC high-voltage direct current power supply, and in order to minimize changes and use existing devices as much as possible, generally, an existing alternating current Power Distribution Unit (PDU) 60 is directly used to distribute power to a terminal server 604 as an electrical device. As shown in FIG. 1, under restrictions of space and too many output paths, the alternating circuit PDU 60 that distributes power to the terminal server 604 is configured with only one air circuit breaker 601. Normally, each output branch cannot be configured with an independent high-voltage direct current air circuit breaker 601 for separate protection. This results in that a power-down operation can be performed on the terminal server only by directly unplugging a connector 603 on the PDU 60 side or unplugging a connector 605 on the terminal server 604 side. However, when the connector 603 or the connector 605 is unplugged due to a maloperation, a high-voltage direct current load that is cut off may cause arc blast, which is harmful to an operator and is extremely dangerous.

As shown in FIG. 2, at present, a dedicated PDU supporting a 240 V direct current (DC) power supply is available in the industry to distribute power to a server 704, where an input end of a direct current power supply of a PDU 70 is protected by using a 240 V DC dedicated dual-pole air circuit breaker 701, and a connector 702 uses a connector of 240 V DC or a higher direct-current voltage level as an output interface.

By using the connector 702 of 240 V DC or a higher direct-current voltage level as the output interface, high-voltage arc blast caused by an unplugging operation on the PDU 70 side may be effectively suppressed. However, because an IT device on a live network remains unchanged, a connector 7041 on the server 704 side is still an original alternating current connector. As a result, on the server 704 side, when a connector 705 is unplugged due to a maloperation, arc blast may still be caused by a high-voltage direct current load that is cut off, which is harmful to an operator and is extremely dangerous.

Moreover, the PDU 70 using a dedicated high-voltage direct current connector is much more expensive and bigger than a common alternating current connector, resulting in that the volume and cost of the PDU 70 increase greatly compared with the common alternating current PDU.

In addition, a cable connector 703 for connecting the server 704 to the PDU 70 also requires a dedicated high-voltage direct current connector, which increases the cost.

Further, when the dedicated high-voltage direct current connector is hot-plugged and a high-voltage direct current is cut off, a high-voltage direct current arc may damage a contact of the connector, which limits the service life of the connector that is hot-plugged. At present, a high-voltage direct current connector generally can be hot-plugged for about 50 times.

### SUMMARY

The main technical problem to be solved by the present invention is to provide a power distribution system and a power distribution unit, which can, under the circumstance that no major modification is made to an electrical device and a cable module for connection on a live network, and with a precondition that a volume of the power distribution unit does not increase while a cost increases slightly, effectively preventing a high-voltage direct current load that is cut off from causing arc blast when a connector plugged into the power distribution unit side and/or the electrical device side is unplugged, thereby protecting an operator.

In a first aspect, a power distribution unit is provided, including: a first input end, connected to a positive pole of a high-voltage direct current power supply that is input externally; a second input end, connected to a negative pole of the high-voltage direct current power supply; a first output end; a second output end, connected to the second input end; a connector, where the connector is detachably connected to an external connector, and the connector is configured to accommodate the first output end and the second output end, so that output of the first output end and the second output end can be input into the external connector; and a controlled switch set between the first input end and the first output end, configured to control the first input end and the first output end to be connected or disconnected. The controlled switch includes a drive end, a controlled input end, and a controlled output end, where the controlled output end is connected to the first output end and the controlled input end is connected to the first input end. When the drive end receives a first drive signal, the controlled input end is connected to the controlled output end; when the drive end receives a second drive signal, the controlled input end is disconnected from the controlled output end. The drive end receives the first drive signal when the external connector is plugged into the connector, and receives the second drive signal when the external connector plugged into the connector is unplugged.

With reference to the implementation manner of the first aspect, in a first possible implementation manner, the power distribution unit further includes a sensing module, where the sensing module is configured to sense whether the external connector plugged into the connector is unplugged; if yes, generate the second drive signal to the drive end; and if no, generate the first drive signal to the drive end.

With reference to the first possible implementation manner of the first aspect, in a second possible implementation manner, the sensing module is an infrared pair tube module, where the infrared pair tube module includes an infrared emitter and an infrared receiver that are set on the connector or the external connector. The infrared emitter is configured to emit an infrared ray, and the infrared receiver is configured to obtain the infrared ray that is reflected when the emitted infrared ray hits an object. The infrared pair tube module further includes a drive circuit, configured to generate the first drive signal to the drive end when the infrared receiver receives a reflected infrared ray whose light intensity is not less than a first threshold; otherwise, generate the second drive signal to the drive end, where the first threshold is a light intensity value of the reflected infrared ray obtained by the infrared receiver when the connector approaches the external connector to a certain extent.

With reference to the second possible implementation manner of the first aspect, in a third possible implementation manner, the sensing module is a micro switch module, including: a micro switch that is set on the connector, including a contact, a first end, a second end, and a third end, where the contact is set to be in a first state when the external connector is plugged into the connector and to be in a second state when the external connector is unplugged from the connector, when the contact is in the first state, the first end is connected to the second end, and when the contact resets resiliently, the first end is connected to the third end; and a drive circuit, configured to generate the first drive signal to the drive end when the first end is connected to the second end, and generate the second drive signal to the drive end when the first end is connected to the third end.

With reference to any one of the implementation manner of the first aspect and the first, the second, and the third possible implementation manners of the first aspect, the controlled switch is a metal-oxide-semiconductor field-effect transistor.

With reference to any one of the implementation manner of the first aspect and the first, the second, and the third possible implementation manners of the first aspect, the connector is a socket and the external connector is a plug.

In a second aspect, a power distribution system is provided, including: a cable module, including a first connector, a second connector, and a cable for connecting the first connector to the second connector; an electrical device, including a third connector, where the third connector is detachably connected to the first connector; and a power distribution unit, including a first input end, connected to a positive pole of a high-voltage direct current power supply that is input externally; a second input end, connected to a negative pole of the high-voltage direct current power supply; a first output end; a second output end, connected to the second input end; a fourth connector, configured to accommodate the first output end and the second output end, where the fourth connector is detachably connected to the second connector, so that output of the first output end and the second output end can be input into the second connector; a controlled switch set between the first input end and the first output end, configured to control the first input end and the first output end to be connected or disconnected, where the controlled switch includes a drive end, a controlled input end, and a controlled output end, the controlled output end is connected to the first output end, the controlled input end is connected to the first input end, when the drive end obtains a first drive signal, the controlled input end is connected to the controlled output end, and when the drive end obtains a second drive signal, the controlled input end is disconnected from the controlled output end; and a first sensing module, configured to sense whether the second connector plugged into the fourth connector is unplugged; if yes, generate the second drive signal to the drive end; and if no, generate the first drive signal to the drive end.

With reference to the implementation manner of the second aspect, in a first possible implementation manner, the first sensing module is an infrared pair tube module, where the infrared pair tube module includes an infrared emitter and an infrared receiver that are set on the second connector or the fourth connector; the infrared emitter is configured to emit an infrared ray; and the infrared receiver is configured to obtain the infrared ray that is reflected when the emitted infrared ray hits an object. The infrared pair tube module further includes a drive circuit, configured to generate the first drive signal to the drive end when the infrared receiver receives a reflected infrared ray whose light intensity is not less than a first threshold; otherwise, generate the second drive signal to the drive end, where the first threshold is a light intensity value of the reflected infrared ray obtained by the infrared receiver when the second connector approaches the fourth connector to a certain extent.

With reference to the implementation manner of the second aspect, in a second possible implementation manner, the first sensing module is a micro switch module, including: a micro switch that is set on the fourth connector, including a contact, a first end, a second end, and a third end, where the contact is set to press against and be compressed by the second connector when the second connector is plugged into the fourth connector, and reset resiliently when the second connector is unplugged from the fourth connector, when the contact is compressed, the first end is connected to the second end, and when the contact resets resiliently, the first end is connected to the third end; and a drive circuit, configured to generate the first drive signal to the drive end when the first end is connected to the second end, and generate the second drive signal to the drive end when first end is connected to the third end.

With reference to the implementation manner of the second aspect, in a third possible implementation manner, the controlled switch is a metal-oxide-semiconductor field-effect transistor.

With reference to the implementation manner of the second aspect, in a fourth possible implementation manner, the power distribution unit further includes a second sensing module, configured to sense whether the first connector plugged into the third connector is unplugged; if yes, generate a first drive signal to the drive end; and if no, generate a second drive signal to the drive end.

With reference to the fourth possible implementation manner of the second aspect, in a fifth possible implementation manner, the second sensing module is an infrared pair tube module, where the infrared pair tube module includes an infrared emitter and an infrared receiver that are set on the first connector or the third connector; the infrared emitter is configured to emit an infrared ray; and the infrared receiver is configured to obtain the infrared ray that is reflected when the emitted infrared ray hits an object. The infrared pair tube module further includes a drive circuit, configured to generate the first drive signal to the drive end when the infrared receiver receives a reflected infrared ray whose light intensity is not less than a first threshold; otherwise, generate the second drive signal to the drive end, where the first threshold is a light intensity value of the reflected infrared ray obtained by the infrared receiver when the first connector approaches the third connector to a certain extent.

With reference to the fourth possible implementation manner of the second aspect, in a sixth possible implementation manner, the second sensing module is a micro switch module, including: a micro switch that is set on the third connector, including a contact, a first end, a second end, and a third end, where the contact is set to press against and be compressed by the first connector when the first connector is plugged into the third connector, and reset resiliently when the first connector is unplugged from the third connector, when the contact is compressed, the first end is connected to the second end, and when the contact resets resiliently, the first end is connected to the third end; and a drive circuit, configured to generate the first drive signal to the drive end when the first end is connected to the second end, and generate the second drive signal to the drive end when the first end is connected to the third end.

With reference to any one of the implementation manner of the second aspect and the first to sixth possible implementation manners of the second aspect, the first connector and the second connector are plugs, and the third connector and the fourth connector are sockets.

In a third aspect, a power distribution system is provided, including: a cable module, including a first connector, a second connector, and a cable for connecting the first connector to the second connector; an electrical device, including a third connector, where the third connector is detachably connected to the first connector; and a power distribution unit, including a first input end, connected to a positive pole of a high-voltage direct current power supply that is input externally; a second input end, connected to a negative pole of the high-voltage direct current power supply; a first output end; a second output end, connected to the second input end; a fourth connector, configured to accommodate the first output end and the second output end, where the fourth connector is detachably connected to the second connector, so that output of the first output end and the second output end can be input into the second connector; a controlled switch set between the first input end and the first output end, configured to control the first input end and the first output end to be connected or disconnected, where the controlled switch includes a drive end, a controlled input end, and a controlled output end, the controlled output end is connected to the first output end, the controlled input end is connected to the first input end, when the drive end obtains a first drive signal, the controlled input end is connected to the controlled output end, and when the drive end obtains a second drive signal, the controlled input end is disconnected from the controlled output end; and a sensing module, configured to sense whether the first connector plugged into the third connector is unplugged; if yes, generate the second drive signal to the drive end; and if no, generate the first drive signal to the drive end.

With reference to the implementation manner of the third aspect, in a first possible implementation manner, the sensing module is an infrared pair tube module, where the infrared pair tube module includes an infrared emitter and an infrared receiver that are set on the first connector or the third connector; the infrared emitter is configured to emit an infrared ray; and the infrared receiver is configured to obtain the infrared ray that is reflected when the emitted infrared ray hits an object. The infrared pair tube module further includes a drive circuit, configured to generate the first drive signal to the drive end when the infrared receiver receives a reflected infrared ray whose light intensity is not less than a first threshold; otherwise, generate the second drive signal to the drive end, where the first threshold is a light intensity value of the reflected infrared ray obtained by the infrared receiver when the first connector approaches the third connector to a certain extent.

With reference to the implementation manner of the third aspect, in a second possible implementation manner, the sensing module is a micro switch module, including: a micro switch that is set on the third connector, including a contact, a first end, a second end, and a third end, where the contact is set to press against and be compressed by the first connector when the first connector is plugged into the third connector, and reset resiliently when the first connector is unplugged from the third connector, when the contact is compressed, the first end is connected to the second end, and when the contact resets resiliently, the first end is connected to the third end; and a drive circuit, configured to generate the first drive signal to the drive end when the first end is connected to the second end, and generate the second drive signal to the drive end when the first end is connected to the third end.

With reference to any one of the implementation manner of the third aspect, the first possible implementation manner of the third aspect, and the second possible implementation manner of the third aspect, in a third possible implementation manner, the controlled switch is a metal-oxide-semiconductor field-effect transistor.

With reference to any one of the implementation manner of the third aspect, the first possible implementation manner of the third aspect, and the second possible implementation manner of the third aspect, in a fourth possible implementation manner, the first connector and the second connector are plugs, and the third connector and the fourth connector are sockets.

Unlike the prior art, the power distribution system and the power distribution unit according to the embodiments of the present invention are configured with a sensing module, where the sensing module is used to sense whether a corresponding connector plugged into a connector is unplugged, and an electrical connection is cut off in the power distribution unit when it is sensed that the corresponding connector is unplugged, so as to effectively prevent, under the circumstance that no major modification is made to an electrical device and a cable module for connection on a live network, and with a precondition that a volume of the power distribution unit does not increase while a cost increases slightly, a high-voltage direct current load that is cut off from causing arc blast when the connector plugged into the power distribution unit side or the electrical device side is unplugged, thereby protecting an operator.

### BRIEF DESCRIPTION OF DRAWINGS

FIG. 1 is a schematic diagram of a circuit structure of a power distribution system according to the prior art;

FIG. 2 is a schematic diagram of a circuit structure of another power distribution system according to the prior art;

FIG. 3 is a schematic diagram of a circuit structure of a power distribution system according to a first embodiment of the present invention;

FIG. 4 is a schematic diagram of a circuit structure of a first sensing module having a micro switch module in a first state according to a first embodiment of the present invention;

FIG. 5 is a schematic diagram of a circuit structure of a first sensing module having a micro switch module in a second state according to a first embodiment of the present invention;

FIG. 6 is a schematic diagram of a circuit structure of a first sensing module having an infrared emitter and an infrared receiver according to a second embodiment of the present invention;

FIG. 7 is a schematic diagram illustrating a location relationship between an infrared emitter and an infrared receiver in a first sensing module according to a second embodiment of the present invention;

FIG. 8 is a schematic diagram of a circuit structure of a power distribution system according to a second embodiment of the present invention;

FIG. 9 is a schematic diagram of a circuit structure of a power distribution system according to a third embodiment of the present invention;

FIG. 10 is a schematic diagram of a circuit structure of a power distribution system according to a fourth embodiment of the present invention; and

FIG. 11 is a schematic diagram of a circuit structure of a power distribution unit according to a first embodiment of the present invention.

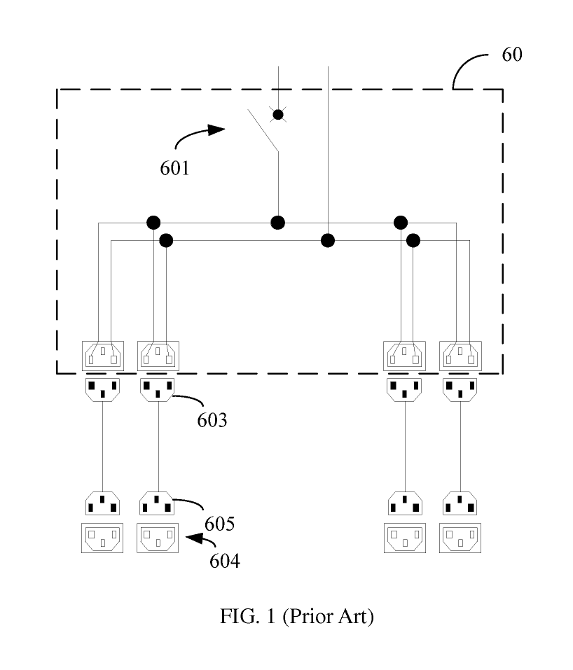

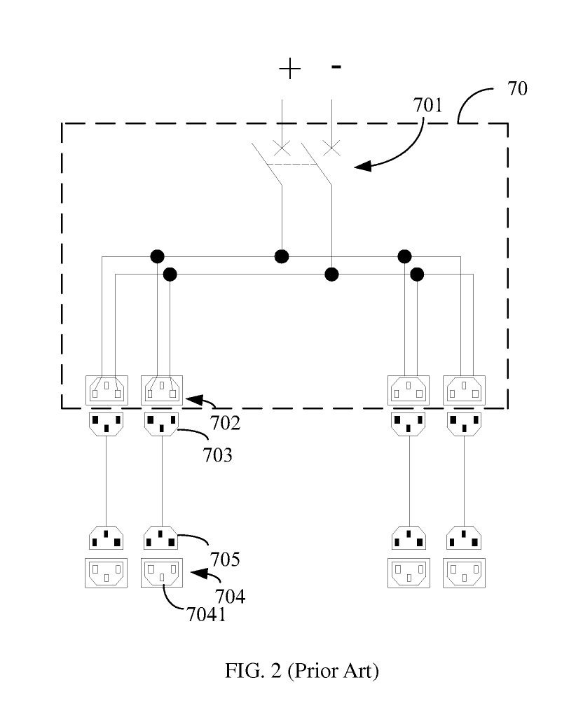

### DESCRIPTION OF EMBODIMENTS

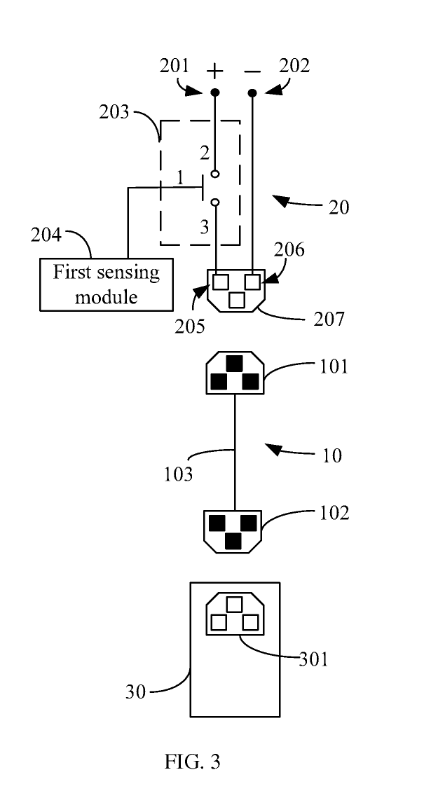

Refer to FIG. 3, where FIG. 3 is a schematic diagram of a circuit structure of a power distribution system according to a first embodiment of the present invention. As shown in FIG. 3, in the power distribution system according to the first embodiment of the present invention, the power distribution system includes a cable module 10, an electrical device 30, and a power distribution unit 20.

The cable module 10 includes a first connector 102, a second connector 101, and a cable 103 for connecting the first connector 102 to the second connector 101.

The electrical device 30 includes a third connector 301, where the third connector 301 is detachably connected to the first connector 102.

The power distribution unit 20 includes: a first input end 201, connected to a positive pole + of a high-voltage direct current power supply that is input externally; a second input end 202, connected to a negative pole − of the high-voltage direct current power supply; a first output end 205; a second output end 206, connected to the second input end 202; a fourth connector 207, configured to accommodate the first output end 205 and the second output end 206, where the fourth connector 207 is detachably connected to the second connector 101, so that output of the first output end 205 and the second output end 206 can be input into the second connector 101; a controlled switch 203 set between the first input end 201 and the first output end 205, configured to control the first input end 201 and the first output end 205 to be connected or disconnected, where the controlled switch 203 includes a drive end 1, a controlled input end 2, and a controlled output end 3, the controlled output end 3 is connected to the first output end 205, the controlled input end 2 is connected to the first input end 201, when the drive end 1 receives a first drive signal, the controlled input end 2 is connected to the controlled output end 3, and when the drive end 1 receives a second drive signal, the controlled input end 2 is disconnected from the controlled output end 3; and a first sensing module 204, configured to sense whether the second connector 101 plugged into the fourth connector 207 is unplugged; if yes, generate the second drive signal to the drive end 1; and if no, generate the first drive signal to the drive end 1.

In this embodiment, because the first sensing module 204 can sense whether the second connector 101 plugged into the fourth connector 207 is unplugged; if yes, generate the second drive signal to the drive end 1; and if no, generate the first drive signal to the drive end 1.

When the first sensing module 204 generates the first drive signal to the drive end 1, the controlled input end 2 and the controlled output end 3 of the controlled switch 203 are connected. Because the controlled output end 3 is connected to the first output end 205 and the controlled input end 2 is connected to the first input end 201, the first input end 201 and the first output end 205 are connected. In such cases, the positive pole + of the high-voltage direct current power supply that is input externally is connected to the first output end 205, and the negative pole − is connected to the second output end 206; the power distribution unit 20 outputs a high-voltage direct current power supply by using the first output end 205 and the second output end 206.

When the first sensing module 204 generates the second drive signal to the drive end 1, the controlled input end 2 and the controlled output end 3 of the controlled switch 203 are disconnected. Because the controlled output end 3 is connected to the first output end 205 and the controlled input end 2 is connected to the first input end 201, the first input end 201 and the first output end 205 are disconnected. In such cases, although the negative pole − of the high-voltage direct current power supply that is input externally is still connected to the second output end 206, the positive pole + of the high-voltage direct current power supply that is input externally is disconnected from the first output end 205, resulting in that the high-voltage direct current power supply is disconnected inside the power distribution unit 20. Because an operator unplugs the second connector 101 from the fourth connector 207 outside the power distribution unit 20, and the action of unplugging the second connector 101 from the fourth connector 207 can trigger the first sensing module 204 to generate the second drive signal, where the second drive signal can drive the controlled switch 203 to disconnect the first input end 201 from the first output end 205, the high-voltage direct current power supply is disconnected inside the power distribution unit 20, so as to effectively prevent a high-voltage direct current load that is cut off on the fourth connector 207 from causing arc blast when the second connector 101 plugged into the power distribution unit 20 side is unplugged, thereby protecting an operator.

The power distribution system according to the first embodiment of the present invention is particularly suitable for a case where the operator is required to plug and unplug only the second connector 101 on the power distribution unit 20 side.

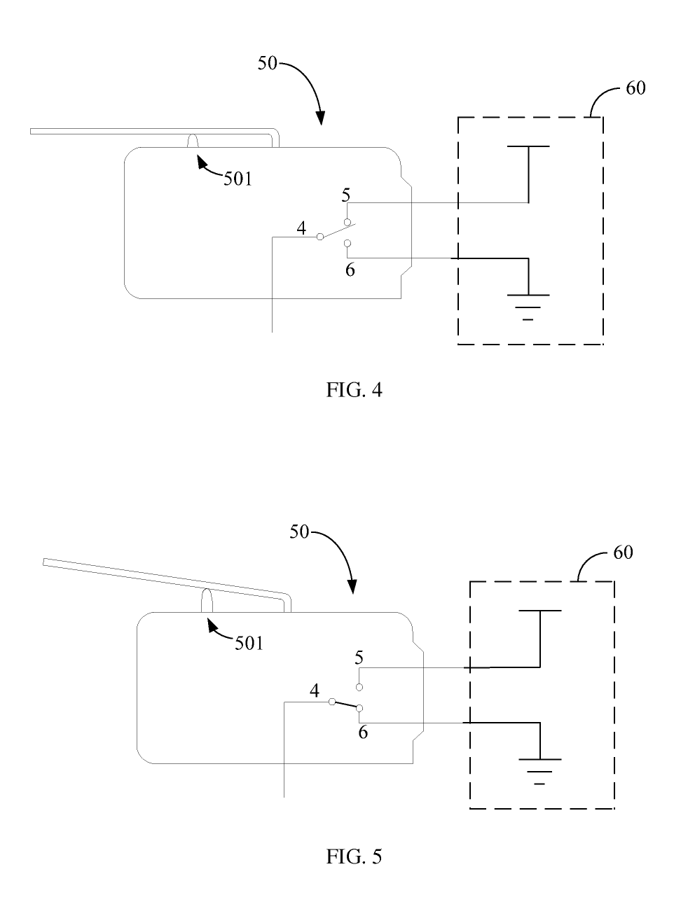

Refer to FIG. 4 and FIG. 5 for the specific description of the first sensing module 204 according to the first embodiment. In the first embodiment of the first sensing module 204, the first sensing module 204 specifically is a micro switch module. FIG. 4 is a schematic diagram of a circuit structure of the first sensing module having the micro switch module in a first state according to the first embodiment of the present invention, and FIG. 5 is a schematic diagram of a circuit structure of the first sensing module having the micro switch module in a second state according to the first embodiment of the present invention. When the micro switch module is in the first state, a contact 501 is in a compressed state; and when the micro switch module is in the second state, the contact 501 is in a stretched state.

As shown in FIGS. 4-5, the micro switch module includes a micro switch 50 and a drive circuit 60.

The micro switch 50 is set on the fourth connector 207, and includes the contact 501, a first end 4, a second end 5, and a third end 6. The contact 501 is set to press against and be compressed by the second connector 101 to be in the first state, that is, the compressed state, when the second connector 101 is plugged into the fourth connector 207, and to reset resiliently to be in the second state, that is, the stretched state, when the second connector 207 is unplugged from the fourth connector 207. When the contact 501 is compressed by pressing, the first end 4 is connected to the second end 5; and when the contact 501 resets resiliently to be stretched, the first end 4 is connected to the third end 6.

The drive circuit 60 generates the first drive signal to the drive end 1 when the first end 4 is connected to the second end 5, and generates the second drive signal to the drive end 1 when the first end 4 is connected to the third end 6. This embodiment illustrates a simplest implementation manner of the drive circuit 60, that is, the second end 5 is directly connected to the direct-current voltage source, and the third end 6 is grounded, so as to generate a high level second drive signal or generate a low level first drive signal to the drive end 1.

Therefore, by using the setting described above, the micro switch 50 may be used to sense whether the second connector 101 plugged into the fourth connector 207 is unplugged, and the drive circuit 60 is used to generate a corresponding first or second drive signal to the drive end 1 of the controlled switch 203 according to an unplugging state, so as to implement an action detecting function of the first sensing module 204.

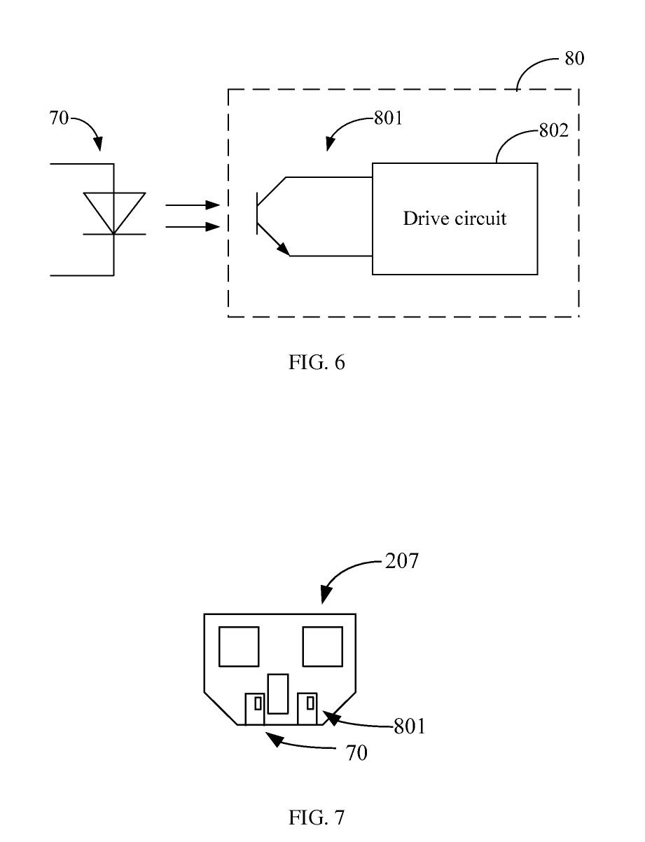

Moreover, refer to FIG. 6 and FIG. 7 for the specific description of the first sensing module 204 according to a second embodiment. In the second embodiment of the first sensing module 204, the first sensing module 204 specifically is an infrared pair tube module. FIG. 6 is a schematic diagram of a circuit structure of the first sensing module according to the second embodiment of the present invention, and FIG. 7 is a schematic diagram illustrating a location relationship between an infrared emitter and an infrared receiver in the first sensing module according to the second embodiment of the present invention.

As shown in FIG. 6, the infrared pair tube module includes an infrared emitter 70 and a receiving unit 80. The infrared emitter 70 and the receiving unit 80 are set on the second connector 101 or the fourth connector 207. The infrared emitter 70 is configured to emit an infrared ray. The receiving unit 80 is configured to receive an infrared ray that is reflected when the emitted infrared ray hits an object. The infrared pair tube module further includes an infrared receiver 801 and a drive circuit 802.

The infrared receiver 801 is set opposite to the infrared emitter 70, and is configured to obtain the infrared ray. The drive circuit 802 generates a first drive signal to the drive end 1 when the infrared receiver 801 obtains a reflected infrared ray whose light intensity is not less than a first threshold; otherwise, generates a second drive signal to the drive end 1. The first threshold is a light intensity value of the reflected infrared ray obtained by the infrared receiver 801 when the second connector 101 and the fourth connector 207 approach to a certain extent.

Because lightness of the infrared emitter 70 and the receiving unit 80 decreases obviously when the second connector 101 approaches the fourth connector 207 to a certain extent, by detecting the light intensity of the infrared ray between the infrared emitter 70 and the receiving unit 80, it may be accurately determined whether the second connector 101 and the fourth connector 207 are in an unplugged or plugged state. The first threshold may be obtained by experiments. The present invention sets no limit on a specific value of the first threshold.

In addition, the drive circuit 802 of the infrared pair tube is a common technology in the field, and a variety of existing circuit structures may be used to implement functions of the drive circuit 802; therefore, no specific description is provided herein.

Refer to FIG. 7. As shown in FIG. 7, the infrared emitter 70 and the infrared receiver 801 may be correspondingly set on the fourth connector 207, where the infrared receiver 801 detects an infrared ray that is reflected when the emitted infrared ray hits an object when the second connector 101 is plugged into or unplugged from the fourth connector 207.

Therefore, by using the setting described above, the infrared pair tube module may be used to sense whether the second connector 101 plugged into the fourth connector 207 is unplugged, and the drive circuit 802 is used to generate a corresponding first or second drive signal to the drive end 1 of the controlled switch 203 according to an unplugged state, so as to implement a corresponding function of the first sensing module 204.

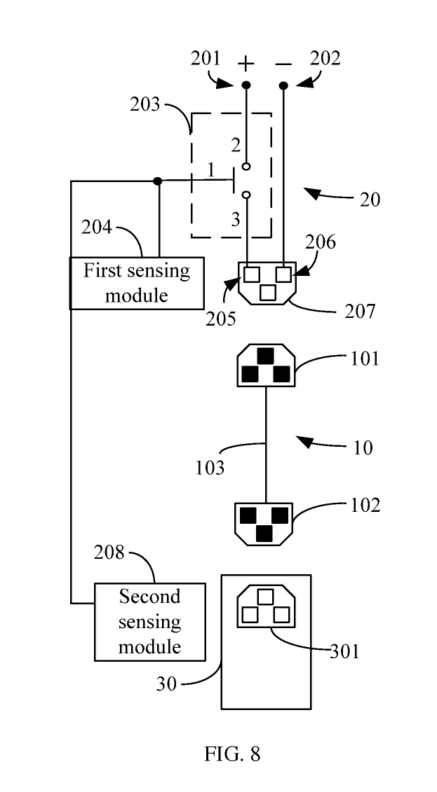

Refer to FIG. 8. FIG. 8 is a schematic diagram of a circuit structure of a power distribution system according to a second embodiment of the present invention. As shown in FIG. 8, in the power distribution system according to the second embodiment of the present invention, a second sensing module 208 is added on the basis of the power distribution system according to the first embodiment. The second sensing module 208 is configured to sense whether the first connector 102 plugged into the third connector 301 is unplugged; if yes, generate a first drive signal to the drive end 1; and if no, generate a second drive signal to the drive end 1.

The second sensing module 208 may also be implemented by using the micro switch module or the infrared pair tube module described above, and details are not described herein again.

Similar to the function of the first sensing module 204, after the second sensing module 208 is added, the power distribution system in the present invention can further sense whether the first connector 102 plugged into the third connector 301 is unplugged, so as to effectively prevent a high-voltage direct current load that is cut off on the third connector 301 from causing arc blast when the first connector 102 plugged into the electrical device 30 side is unplugged, thereby protecting an operator on the electrical device 30 side.

The power distribution system according to the second embodiment of the present invention is particularly suitable for a case where an operator plugs or unplugs the first connector 102 on the electrical device 30 side or the second connector 101 on the power distribution unit 20 side.

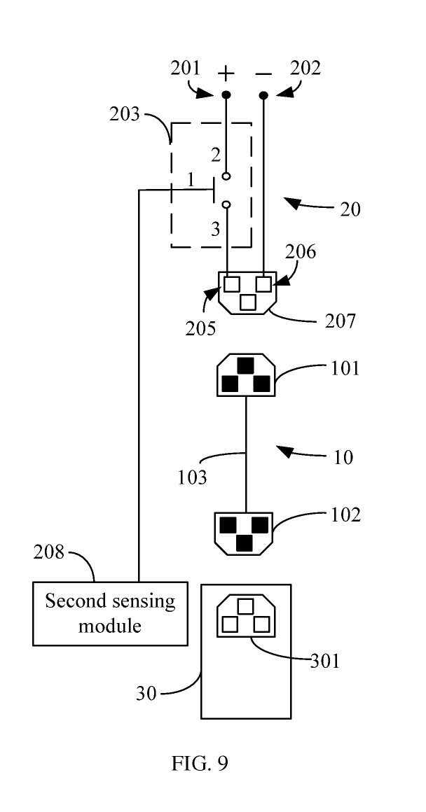

Refer to FIG. 9. FIG. 9 is a schematic diagram of a circuit structure of a power distribution system according to a third embodiment of the present invention. As shown in FIG. 9, in the power distribution system according to the third embodiment of the present invention, the first sensing module 204 is removed on the basis of the power distribution system according to the second embodiment, and only the second sensing module 208 is used to sense whether the first connector 102 plugged into the third connector 301 is unplugged; if yes, generate a second drive signal to the drive end 1; and if no, generate a first drive signal to the drive end 1.

In the power distribution system according to the third embodiment of the present invention, only the second sensing module 208 is used to sense an action of unplugging the first connector 102 on the electrical device 30 side, and generate a second drive signal when the first connector 102 is unplugged to disconnect the controlled input end 2 from the controlled output end 3 of the controlled switch 203, which cuts off the power supply inside the power distribution unit 20, so as to effectively prevent a high-voltage direct current load that is cut off on the first connector 102 from causing arc blast when the first connector 102 plugged into the electrical device 30 side is unplugged, thereby protecting an operator.

The power distribution system according to the third embodiment of the present invention is particularly suitable for a case where the operator is required to plug and unplug only the first connector 102 on the electrical device 30 side.

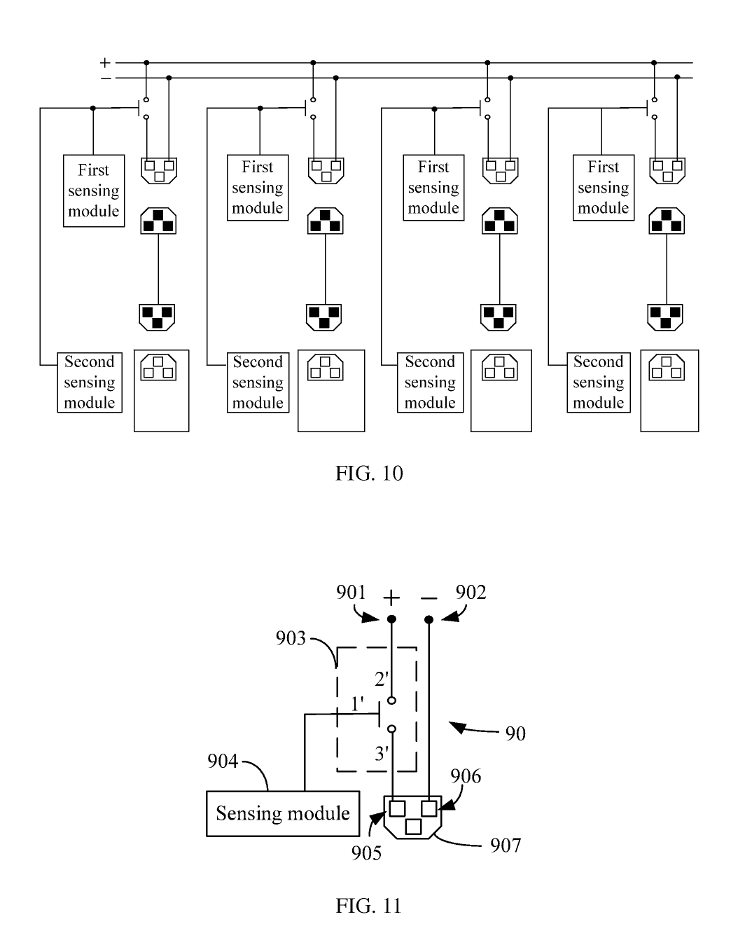

Refer to FIG. 10. FIG. 10 is a schematic diagram of a circuit structure of a power distribution system according to a fourth embodiment of the present invention. As shown in FIG. 10, in the power distribution system according to the fourth embodiment of the present invention, multiple power distribution units and electrical devices are configured, and multiple cable modules are used to connect them.

The power distribution system according to the fourth embodiment of the present invention can, by integrating multiple power distribution units, cable modules, and electrical devices, implement an application of large-scale power distribution.

It should be noted that, in the embodiments described above, the controlled switch 203 may be implemented by using a metal-oxide-semiconductor field-effect transistor, an analog switch, a relay, or another switch module that can achieve the same function. However, because of a low cost of the metal-oxide-semiconductor field-effect transistor, considering a cost factor, the controlled switch 203 may be implemented preferentially by using the metal-oxide-semiconductor field-effect transistor.

In addition, in the embodiments described above, the first connector 102 and the second connector 101 preferentially are plugs, and the third connector 301 and the fourth connector 207 preferentially are sockets. However, in the above embodiments, the first connector 102 and the second connector 101 may also be sockets, and the third connector 301 and the fourth connector 207 may also be plugs, which may implement the same technical effect. The present invention sets no specific limit thereto.

Finally, refer to FIG. 11. FIG. 11 is a schematic diagram of a circuit structure of a power distribution unit according to a first embodiment of the present invention. As shown in FIG. 11, the power distribution unit 90 according to the present invention includes: a first input end 901, connected to a positive pole + of a high-voltage direct current power supply that is input externally; a second input end 902, connected to a negative pole − of the high-voltage direct current power supply; a first output end 905; a second output end 906, connected to the second input end 902; a connector 907, where the connector 907 is detachably connected to an external connector (not shown in the figure), and the connector 907 is configured to accommodate the first output end 905 and the second output end 906, so that output of the first output end 905 and the second output end 906 can be input into the external connector; and a controlled switch 903 set between the first input end 901 and the first output end 905, configured to control the first input end 901 and the first output end 905 to be connected or disconnected. The controlled switch 903 includes a drive end 1′, a controlled input end 2′, and a controlled output end 3′. The controlled output end 3′ is connected to the first output end 905 and the controlled input end 2′ is connected to the first input end 901. When the drive end 1′ receives a first drive signal, the controlled input end 2′ is connected to the controlled output end 3′; when the drive end 1′ receives a second drive signal, the controlled input end 2′ is disconnected from the controlled output end 3′. The drive end 1′ receives the first drive signal when the external connector is plugged into the connector 907, and receives the second drive signal when the external connector plugged into the connector 907 is unplugged.

A sensing module 904 is configured to sense whether the external connector plugged into the connector 907 is unplugged; if yes, generate a second drive signal to the drive end 1′; and if no, generate a first drive signal to the drive end 1′.

Similar to the embodiments described above, the sensing module 904 may be implemented by using the infrared pair tube module or the micro switch module, and the controlled switch 903 is implemented preferentially by using a metal-oxide-semiconductor field-effect transistor.

In addition, the connector 907 preferentially is a socket, and the external connector preferentially is a plug. However, the connector 907 may also be set as a plug, and the external connector may be set as a socket.

This power distribution unit 90 may be directly modified on the basis of an existing alternating current PDU. That is, the controlled switch 903 and the sensing module 904 are added on the basis of the existing alternating current PDU. With a precondition that no major modification is made to the existing alternating current PDU, this can prevent a high-voltage direct current load that is cut off from causing arc blast when a connector plugged into the power distribution unit is unplugged, thereby protecting an operator. Therefore, this power distribution unit 90 is particularly suitable for a project such as transforming an equipment room of a data center using an alternating current UPS power supply into one using a 240 V HVDC high-voltage direct current power supply.

According to the above description, the present invention achieves that under the circumstance that no major modification is made to an electrical device and a cable module for connection on a live network, and with a precondition that a volume of the power distribution unit does not increase while a cost increases slightly, a case is effectively avoided where a high-voltage direct current load that is cut off causes arc blast when a connector plugged into the power distribution unit side or the electrical device side is unplugged, thereby protecting an operator.

The foregoing descriptions are merely embodiments of the present invention, and are not intended to limit the scope of the present invention. An equivalent structural or equivalent process alternative made by using the content of the specification and drawings of the present invention, or an application of the content of the specification and drawings directly or indirectly to another related technical field, shall fall within the protection scope of the present invention.

What is claimed is:

1. A power distribution unit, comprising:
a first input end connected to a positive pole of a high-voltage direct current power supply that is input externally;
a second input end connected to a negative pole of the high-voltage direct current power supply;
a first output end;
a second output end connected to the second input end;
a connector detachably connected to an external connector, wherein the connector is configured to accommodate the first output end and the second output end so that output of the first output end and the second output end can be input into the external connector; and
a controlled switch set between the first input end and the first output end, wherein the controlled switch is configured to control the first input end and the first output end to be connected or disconnected, and wherein the controlled switch comprises:
a drive end;
a controlled input end connected to the first input end; and
a controlled output end connected to the first output end,
wherein when the drive end receives a first drive signal, the controlled input end is connected to the controlled output end,
wherein when the drive end receives a second drive signal, the controlled input end is disconnected from the controlled output end, and
wherein the drive end receives the first drive signal when the external connector is plugged into the connector and receives the second drive signal when external connector plugged into the connector is unplugged.

2. The power distribution unit according to claim 1, wherein the power distribution unit further comprises a sensing module configured to:
sense whether the external connector is plugged into the connector;
generate the second drive signal to the drive end when the external connector is not plugged into the connector; and
generate the first drive signal to the drive end when the external connector is plugged into the connector.

3. The power distribution unit according to claim 2, wherein the sensing module comprises an infrared pair tube module comprising an infrared emitter and an infrared receiver that are set on the connector or the external connector, wherein the infrared emitter is configured to emit an infrared ray, wherein the infrared receiver is configured to obtain the infrared ray that is reflected when the emitted infrared ray hits an object, and wherein the infrared pair tube module further comprises a drive circuit configured to:
generate the first drive signal to the drive end when the infrared receiver obtains the reflected infrared ray whose light intensity is not less than a first threshold, wherein the first threshold is a light intensity value of the reflected infrared ray obtained by the infrared receiver when the connector approaches the external connector to a certain extent; and
generate the second drive signal to the drive end when the infrared receiver obtains the reflected infrared ray whose light intensity is less than a first threshold.

4. The power distribution unit according to claim 2, wherein the sensing module comprises a micro switch module comprising:
a micro switch set on the connector and comprising a contact, a first end, a second end, and a third end, wherein the contact is set to be in a first state when the external connector is plugged into the connector, and to be in a second state when the external connector is unplugged from the connector, wherein when the contact is in the first state, the first end is connected to the second end, and wherein when the contact resets resiliently, the first end is connected to the third end; and
a drive circuit configured to generate a first drive signal to the drive end when the first end is connected to the second end, and generate a second drive signal to the drive end when the first end is connected to the third end.

5. The power distribution unit according to claim 1, wherein the controlled switch comprises a metal-oxide-semiconductor field-effect transistor.

6. The power distribution unit according to claim 1, wherein the connector comprises a socket, and wherein the external connector comprises a plug.

7. A power distribution system, comprising:
a cable module comprising a first connector, a second connector, and a cable for connecting the first connector to the second connector;
an electrical device comprising a third connector, wherein the third connector is detachably connected to the first connector; and
a power distribution unit comprising:
a first input end connected to a positive pole of a high-voltage direct current power supply that is input externally;
a second input end connected to a negative pole of the high-voltage direct current power supply;
a first output end;
a second output end connected to the second input end;
a fourth connector configured to accommodate the first output end and the second output end, wherein the fourth connector is detachably connected to the second connector so that output of the first output end and the second output end can be input into the external connector; and
a controlled switch set between the first input end and the first output end, wherein the controlled switch is configured to control the first input end and the first output end to be connected or disconnected, and wherein the controlled switch comprises:
a drive end;
a controlled input end connected to the first input end; and
a controlled output end connected to the first output end,
wherein when the drive end obtains a first drive signal, the controlled input end is connected to the controlled output end, and
wherein when the drive end obtains a second drive signal, the controlled input end is disconnected from the controlled output end; and
a first sensing module configured to:
sense whether the second connector is plugged into the fourth connector;
generate the second drive signal to the drive end when the second connector is not plugged into the fourth connector; and
generate the first drive signal to the drive end when the second connector is plugged into the fourth connector.

8. The power distribution system according to claim 7, wherein the first sensing module comprises an infrared pair tube module comprising an infrared emitter and an infrared receiver that are set on the second connector or the fourth connector, wherein the infrared emitter is configured to emit an infrared ray, wherein the infrared receiver is configured to obtain the infrared ray that is reflected when the emitted infrared ray hits an object, and wherein the infrared pair tube module further comprises:
a drive circuit configured to generate the first drive signal to the drive end when the infrared receiver obtains the reflected infrared ray whose light intensity is not less than a first threshold, wherein the first threshold is a light intensity value of the reflected infrared ray obtained by the infrared receiver when the second connector approaches the fourth connector to a certain extent;
generate the second drive signal to the drive end when the infrared receiver obtains the reflected infrared ray whose light intensity is less than the first threshold.

9. The power distribution system according to claim 7, wherein the first sensing module comprises a micro switch module comprising:
a micro switch set on the fourth connector and comprising a contact, a first end, a second end, and a third end, wherein the contact is set to press against and be compressed by the second connector when the second connector is plugged into the fourth connector, and reset resiliently when the second connector is unplugged from the fourth connector, wherein when the contact is compressed, the first end is connected to the second end, and wherein when the contact resets resiliently, the first end is connected to the third end; and
a drive circuit configured to generate the first drive signal to the drive end when the first end is connected to the second end, and generate the second drive signal to the drive end when the first end is connected to the third end.

10. The power distribution system according to claim 7, wherein the controlled switch comprises a metal-oxide-semiconductor field-effect transistor.

11. The power distribution system according to claim 7, wherein the power distribution unit further comprises a second sensing module configured to:
sense whether the first connector is plugged into the third connector;
generate the second drive signal to the drive end when the first connector is not plugged into the third connector; and
generate the first drive signal to the drive end when the first connector is plugged into the third connector.

12. The power distribution system according to claim 11, wherein the second sensing module comprises an infrared pair tube module comprising an infrared emitter and an infrared receiver that are set on the first connector or the third connector, wherein the infrared emitter is configured to emit an infrared ray, wherein the infrared receiver is configured to obtain the infrared ray that is reflected when the emitted infrared ray hits an object, and wherein the infrared pair tube module further comprises a drive circuit configured to:
generate the first drive signal to the drive end when the infrared receiver obtains the reflected infrared ray whose light intensity is not less than a first threshold, wherein the first threshold is a light intensity value of the reflected infrared ray obtained by the infrared receiver when the first connector approaches the third connector to a certain extent; and
generate the second drive signal to the drive end when the infrared receiver obtains the reflected infrared ray whose light intensity is less than the first threshold.

13. The power distribution system according to claim 11, wherein the second sensing module comprises a micro switch module, comprising:
a micro switch set on the third connector and comprising a contact, a first end, a second end, and a third end, wherein the contact is set to press against and be compressed by the first connector when the first connector is plugged into the third connector, and reset resiliently when the first connector is unplugged from the third connector, wherein when the contact is compressed, the first end is connected to the second end, and wherein when the contact resets resiliently, the first end is connected to the third end; and
a drive circuit configured to generate the first drive signal to the drive end when the first end is connected to the second end, and generate the second drive signal to the drive end when the first end is connected to the third end.

14. The power distribution system according to claim 7, wherein the first connector and the second connector comprise plugs, and wherein the third connector and the fourth connector comprise sockets.

15. A power distribution system, comprising:
a cable module comprising a first connector, a second connector, and a cable for connecting the first connector to the second connector;
an electrical device comprising a third connector, wherein the third connector is detachably connected to the first connector; and
a power distribution unit comprising:
a first input end connected to a positive pole of a high-voltage direct current power supply that is input externally;
a second input end connected to a negative pole of the high-voltage direct current power supply;
a first output end;
a second output end, connected to the second input end;
a fourth connector, configured to accommodate the first output end and the second output end, wherein the fourth connector is detachably connected to the second connector so that output of the first output end and the second output end can be input into an external connector; and
a controlled switch set between the first input end and the first output end,
wherein the controlled switch is configured to control the first input end and the first output end to be connected or disconnected, and wherein the controlled switch comprises:
a drive end;
a controlled input end connected to the first input end; and
a controlled output end connected to the first output end,
wherein when the drive end obtains a first drive signal, the controlled input end is connected to the controlled output end, and
wherein when the drive end obtains a second drive signal, the controlled input end is disconnected from the controlled output end; and
a sensing module configured to:
sense whether the first connector is plugged into the third connector;
generate the second drive signal to the drive end when the first connector is not plugged into the third connector; and
generate the first drive signal to the drive end when the first connector is plugged into the third connector.

16. The power distribution system according to claim 15, wherein the sensing module comprises an infrared pair tube module comprising an infrared emitter and an infrared receiver that are set on the first connector or the third connector, wherein the infrared emitter is configured to emit an infrared ray, wherein the infrared receiver is configured to obtain the infrared ray that is reflected when the emitted infrared ray hits an object, and wherein the infrared pair tube module further comprises:
a drive circuit configured to generate the first drive signal to the drive end when the infrared receiver obtains the reflected infrared ray whose light intensity is not less than a first threshold, wherein the first threshold is a light intensity value of the reflected infrared ray obtained by the infrared receiver when the first connector approaches the third connector to a certain extent; and
generate the second drive signal to the drive end when the infrared receiver obtains the reflected infrared ray whose light intensity is less than the first threshold.

17. The power distribution system according to claim 15, wherein the sensing module comprises a micro switch module comprising:
a micro switch set on the third connector and comprising a contact, a first end, a second end, and a third end, wherein the contact is set to press against and be compressed by the first connector when the first connector is plugged into the third connector, and reset resiliently when the first connector is unplugged from the third connector, wherein when the contact is compressed, the first end is connected to the second end, and wherein when the contact resets resiliently, the first end is connected to the third end; and
a drive circuit configured to generate the first drive signal to the drive end when the first end is connected to the second end, and generate the second drive signal to the drive end when the first end is connected to the third end.

18. The power distribution system according to claim 15, wherein the controlled switch comprises a metal-oxide-semiconductor field-effect transistor.

19. The power distribution system according to claim 15, wherein the first connector and the second connector comprise plugs, and wherein the third connector and the fourth connector comprise sockets.
